(19) United States
(12) Patent Application Publication
(10) Pub. No.: US 2008/0186287 A1
(43) Pub. Date: Aug. 7, 2008

(54) User input device

(75) Inventor: Sami Saila, Halikko (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/702,686

(22) Filed: Feb. 5, 2007

(51) Int. Cl. G06F 3/041

(52) U.S. Cl. 345/174

(57) ABSTRACT

A user input device for an electronic apparatus including a roller and a sensor system. The roller is adapted to be axially rotated by a user. The roller comprises an elongate longitudinal length. The sensor system is adapted to sense a position of the finger of the user relative to the longitudinal length of the roller.

### BACKGROUND OF THE INVENTION

1. Field of the Invention

The invention relates to a user input device for an electronic apparatus and, more particularly, to a user input device having a roller.

2. Brief Description of Prior Developments

Radio telephone handsets have displays where text and graphics are displayed. A user can scroll through a menu or telephone numbers or even play games by use of arrow keys (up/down and/or left/right) on the handset. U.S. Pat. No. 6,480,185 describes a user input device in a portable radio telephone which uses a trackball-type of input. U.S. Pat. No. 7,123,240 describes another type of user input for a portable electronic device having a joystick. Various scrolling solutions and keypads have been used. For example IPOD has a scrolling device where the user rotates his finger to go up and down.

Modern day mobile telephones are known to have other applications and features including, for example, a camera, a music player, a gaming application, an internet browser, etc. Other types of hand-held portable electronic devices which have a display and a user input include a PDA or even a laptop computer. In the future, most hand-held portable electronic devices are expected to have some type of navigation device in them. Besides known trackball, joystick, multi-key keypads, and small flat touch sensors, display touch screens are also known, but can be expensive.

Displays are becoming bigger at the same time that hand-held portable electronic products are becoming smaller. Content that is displayed on hand-held portable electronic devices is often alternatively displayed in a landscape mode or a portrait mode on the same device. Symbols in keypads are too small for many users to read without reading glasses. Language variants to keypads are generating many hardware customized versions to different regions which increases manufacturing costs. It is therefore desirable to use a display for language variants rather than fixed lettering hardware.

There is a desire to provide a new type of user input device. More specifically, there is a desire to provide a user input device which can be ergonomically integrated into an electronic device, such as a hand-held portable electronic device, to provide easy user manipulation and navigation on a display screen. There is also a desire to provide a user input which will accommodate positioning of the hand-held portable electronic device in at least two different orientations, such as portrait and landscape, but still allow use of the same input device to be relatively easy and intuitive in both orientations.

### SUMMARY OF THE INVENTION

In accordance with one aspect of the invention, a user input device for an electronic apparatus including a roller and a sensor system. The roller is adapted to be axially rotated by a user. The roller comprises an elongate longitudinal length which is at least two times longer than a width of a finger of the user. The sensor system is adapted to sense a position of the finger of the user relative to the longitudinal length of the roller.

In accordance with another aspect of the invention, a hand-held portable electronic device is provided comprising a housing; a display connected to the housing; a controller connect to the display; and a user input connected to the controller. The user input comprises a roller and a sensor. The roller is adapted to be axially rotated relative to the housing by a finger of a user to change information displayed on the display. The sensor is adapted for sensing positions of the finger of the user relative to the roller.

In accordance with another aspect of the invention, a method of controlling navigation on a display is provided comprising determining a first input for use in determining a first portion of a position of an item being navigated on the display based, at least partially, upon axial rotation of a user input roller; and determining a second input for use in determining a second portion of a position of the item being navigated on the display based, at least partially, upon a location of a finger of the user on and relative to the user input roller.

In accordance with another aspect of the invention, a method of assembling a portable electronic device comprising connecting a user input roller to a frame of the portable electronic device, wherein the roller has an elongate longitudinal length; providing a first sensing system adapted to sense axial rotation of the roller relative to the housing; and providing a second sensing system adapted to sense a location of a finger of a user at a plurality of locations along the longitudinal length of the roller.

In accordance with another aspect of the invention, a program storage device readable by a machine, tangibly embodying a program of instructions executable by the machine for performing operations to control navigation on a display, the operations is provided comprising determining a first portion of a position of an item being navigated on the display based, at least partially, upon axial rotation of a user input roller; and determining a second portion of a position of the item being navigated on the display based, at least partially, upon a location of a finger of the user on and relative to the user input roller.

### BRIEF DESCRIPTION OF THE DRAWINGS

The foregoing aspects and other features of the invention are explained in the following description, taken in connection with the accompanying drawings, wherein:

FIG. 1 is a perspective view of a hand-held portable electronic device comprising features of the invention;

FIG. 2 is a perspective view of some of the components of the device shown in FIG. 1;

FIG. 3 is a diagram illustrating some of the components of the device shown in FIG. 1;

FIG. 4 is an enlarged, partial perspective view of some of the components shown in FIG. 2;

FIG. 5 is a top plan view of the roller shown in FIGS. 1, 2 and 4;

FIG. 6 is a schematic end view of the roller shown in FIG. 5;

FIG. 7 is a front view of the device shown in FIG. 1 showing use of a user's finger to operate the user input;

FIG. 8 is a front view of the device shown in FIG. 7 showing the device in a landscape orientation for right handed use;

FIG. 9 is a front view of the device shown in FIG. 8 showing the device in a landscape orientation for left handed use;

FIG. 10 is a front view of the device shown in FIG. 7 showing the device in a portrait orientation for bottom located use of the user input roller;

FIG. 11 is a front view of the device shown in FIG. 10 showing the device in a portrait orientation for top located use of the user input roller;

FIG. 12 is a front view of the device shown in FIG. 7 showing the device in a portrait orientation for bottom located use of the user input roller showing using to control navigation of a cursor on the display screen;

FIG. 13 is a front view of the device shown in FIG. 12 showing the device in a landscape orientation for right handed use of the user input roller showing using to control navigation of a cursor on the display screen;

FIG. 14 is a front view of the device shown in FIG. 7 showing the device in a portrait orientation for top located use of the user input roller showing using to control navigation of a map location tool on a map screen shown in the display screen;

FIG. 15 is a front view of the device shown in FIG. 14 showing the device in a landscape orientation for left handed use;

FIG. 16 is a front view of the display and user input with a map screen shown on the display and showing icons on the display which can be highlighted and selected by the user input;

FIG. 17 is a front view of the display and user input as in FIG. 16 with an picture image screen from a viewer application on the display;

FIG. 18 is a perspective view of an alternate embodiment of the device shown in FIG. 1;

FIG. 19 is a partial front view of a device as in FIG. 1 with an alternate embodiment of the user input;

FIG. 20 is a perspective view of another alternate embodiment of the invention;

FIG. 21 is a perspective view of another alternate embodiment of the invention;

FIG. 22 is a diagram illustrating steps of one method of the invention; and

FIG. 23 is a diagram illustrating steps of another method of the invention.

### DETAILED DESCRIPTION OF THE PREFERRED EMBODIMENTS

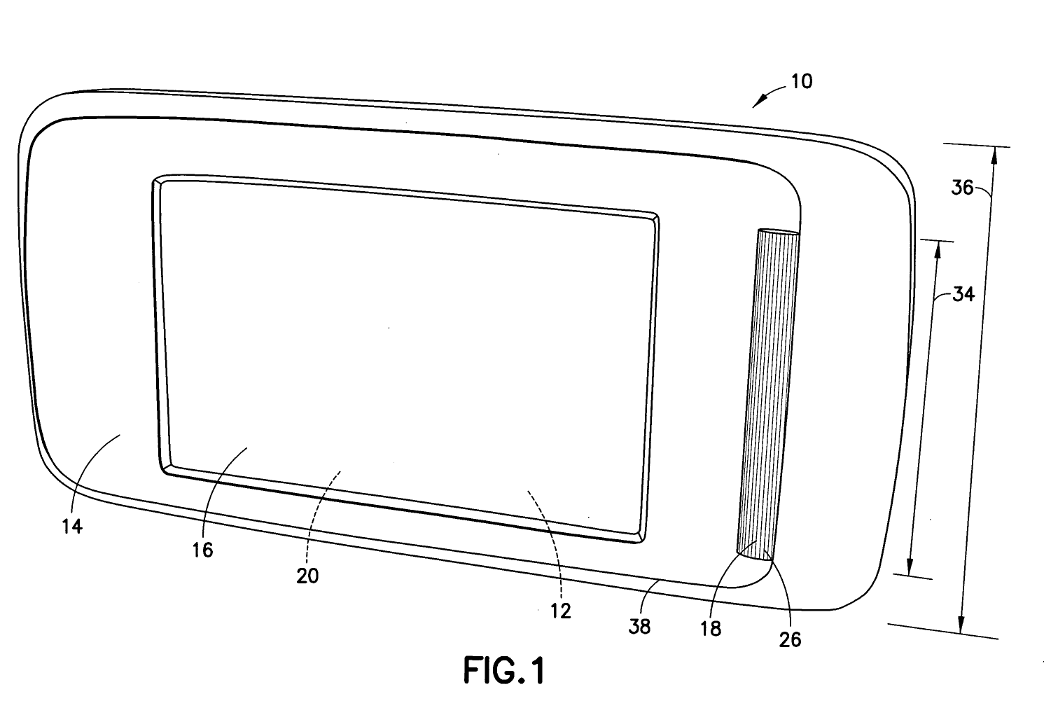

Referring to FIG. 1, there is shown a perspective view of a hand-held portable electronic device 10 incorporating features of the invention. Although the invention will be described with reference to the exemplary embodiments shown in the drawings, it should be understood that the invention can be embodied in many alternate forms of embodiments. In addition, any suitable size, shape or type of elements or materials could be used.

The device 10, in this embodiment, is a communications device having a wireless communications capability. More specifically, the device 10 is a mobile telephone having a transceiver 12. In this embodiment, the device 10 also comprises other features or applications including an Internet browser, a camera and a map navigation. However, in alternate embodiments, more or less features or applications could be provided. For example, the device could comprise a music player and/or a game player. Features of the invention could also be included in a device which does not have a mobile telephone capability, such as an individual hand-held portable gaming device or a digital camera for example. Features of the invention could be used in any suitable type of hand-held portable electronic device including an industrial tool.

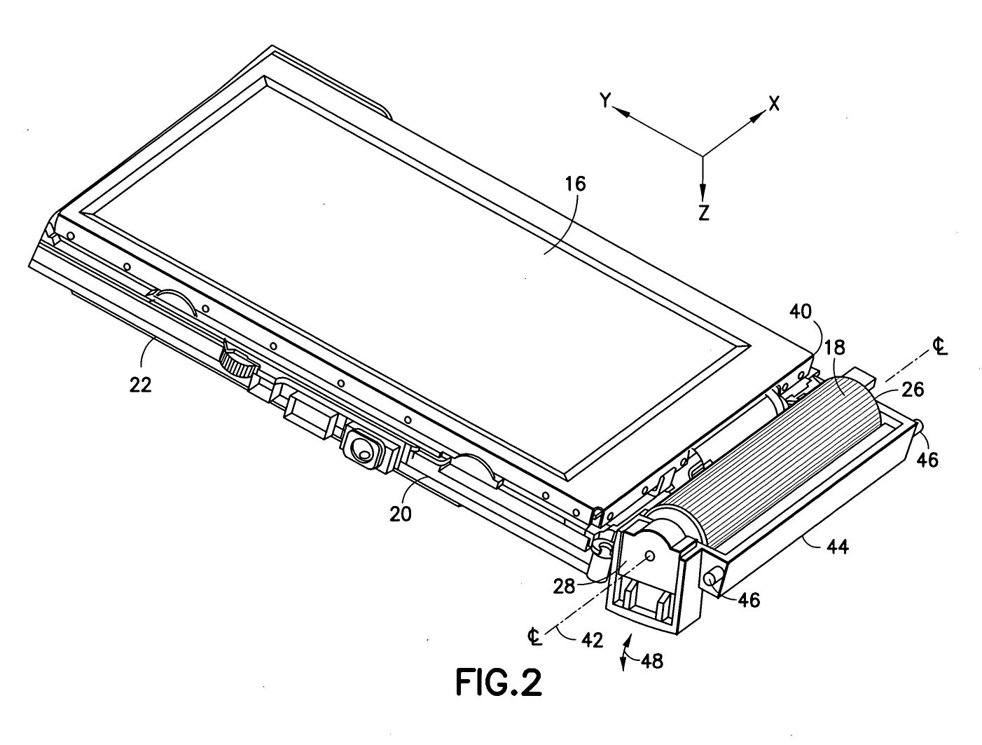

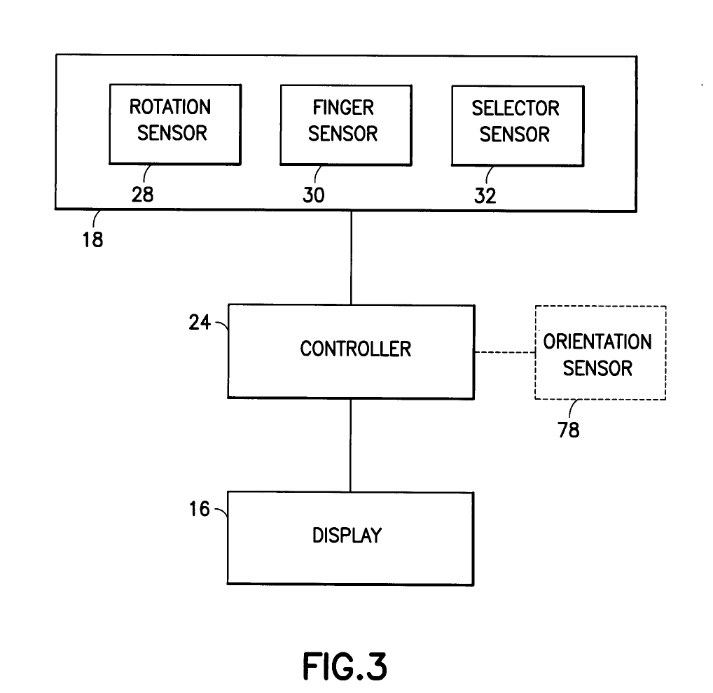

Referring also to FIG. 2, in the embodiment shown, the device 10 generally comprises a housing 14, a display 16, a user input 18, and electronic circuitry 20. The device preferably has a rechargeable battery, but could also be plugged into an electrical outlet or other external electrical supply. The electronic circuitry 20 includes the transceiver 12 and other components well known in the mobile telephone art. Referring also to FIG. 3, this can include a printed circuit board 22 having a controller 24, such as a microprocessor for example, and a memory. The controller is operably connected to the display 16 and the user input 18. In this embodiment the user input comprises a roller 26 (see FIGS. 1 and 2), a rotation sensor 28, a finger sensor 30 and a selector sensor 32. In this embodiment the display 16 has a general rectangular shape. However, in alternate embodiments any suitable shape of display could be provided. The housing 14 also has a general rectangular shape, but in alternate embodiments any suitable shape or configuration of housing could be provided. For example, rather than a substantially monolithic block type housing, the housing could have housing sections which are moveable relative to each other, such as a slide-type mobile telephone, or a flip-type mobile telephone, or have sections which rotate in another fashion relative to each other.

The roller 26 has a general elongate longitudinal length 34. As seen in FIG. 1, in this embodiment the length 34 is more than half the dimension 36 of the housing 14. In the embodiment shown, the length 34 of the roller is about the same length as one side of the display 16. However, in alternative embodiments any suitable length of longitudinally elongate roller could be provided. As can been seen from the description below, the length 34 of the roller 26 is preferably at least two or more times the width of a user's finger. The roller 26 is partially recessed inside the front face 38 of the housing 14, but extends slightly outward from the front face. The part of the roller 26 which extends out of the housing 14 can be contacted by a user's finger such that the user can use his finger to axially rotate the roller 26.

The roller 26 is located proximate one side of the display 16. In this embodiment, the longitudinal axis 42 of the roller is aligned with a shorter side 40 of the rectangular display 16 such that the roller 26 is aligned with one axis X of the display 16. In the embodiment shown, this is orthogonal to the other axis Y of the display 16. However, in an alternate embodiment the roller could be locate along the longer side of the display. In another alternate embodiment, more than one roller could be provided in different locations. The rotational sensor 28 is adapted to sense axial rotation of the roller 26 about the longitudinal axis 42 and send a signal to the controller 24 regarding the sensed rotation.

In this embodiment, the roller 26 is rotatably mounted on a mounting frame 44. The frame 44 is rotatably connected to the housing 14 by pivot pins 46. Thus, the frame 44 is able to pivotably rotate up and down as indicated by arrow 48. Because the roller 26 is connected to the frame 44, the roller 26 is able to move up and down relative to the housing 14 (generally in direction Z). Referring also to FIG. 4, the mounting frame 44 is preferably biased by a spring 50 in an upward direction. This biases the roller 26 in an upward position in the housing front face 38. A user can depress the roller 26 inward (generally in direction Z) with the frame 44 pivotably rotating downward and the spring 50 being compressed. As seen in FIG. 4, the selector sensor 32 is located to sense depression of the roller 26 inward by a user. Thus, the roller can be used as a selector indicator for the device 10. This could be used, for example, to signal the controller 24 to select an item highlighted on the display 16. When the user releases depression of the roller 26, the spring 50 biases the frame 44 and roller 26 back towards their home, up position. In an alternate embodiment the selector sensor 32 might not be provided with the roller 26. Thus, the frame 44 does not need to be pivotably mounted to the housing, and the roller 26 does not need to be able to move in direction Z. In another alternate embodiment, any suitable type of structure to movably mount the roller in axis Z for a selector actuation could be provided.

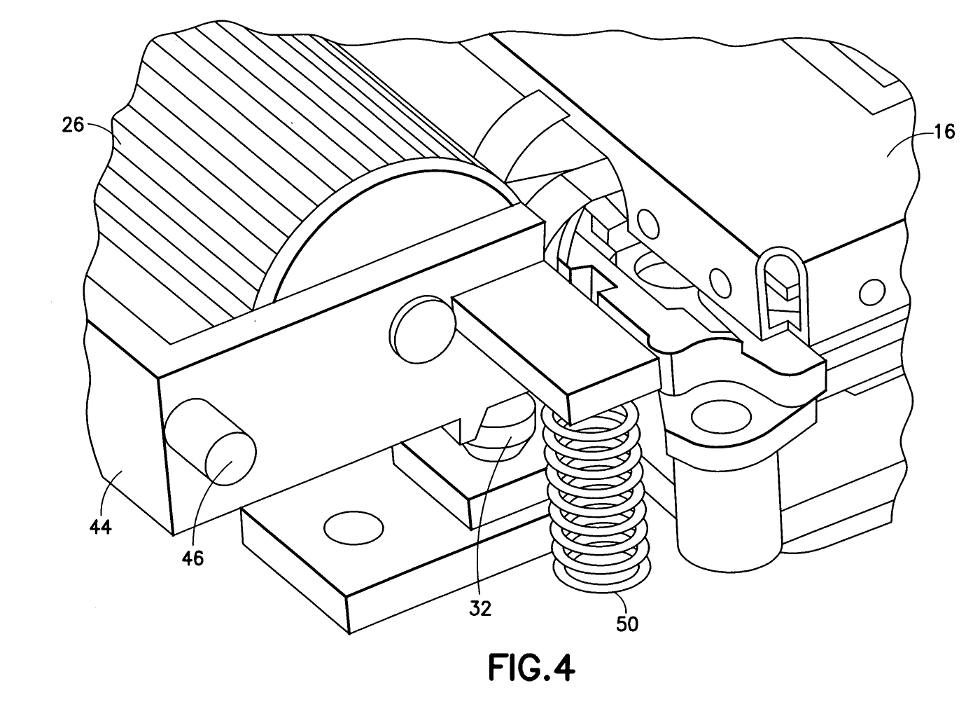

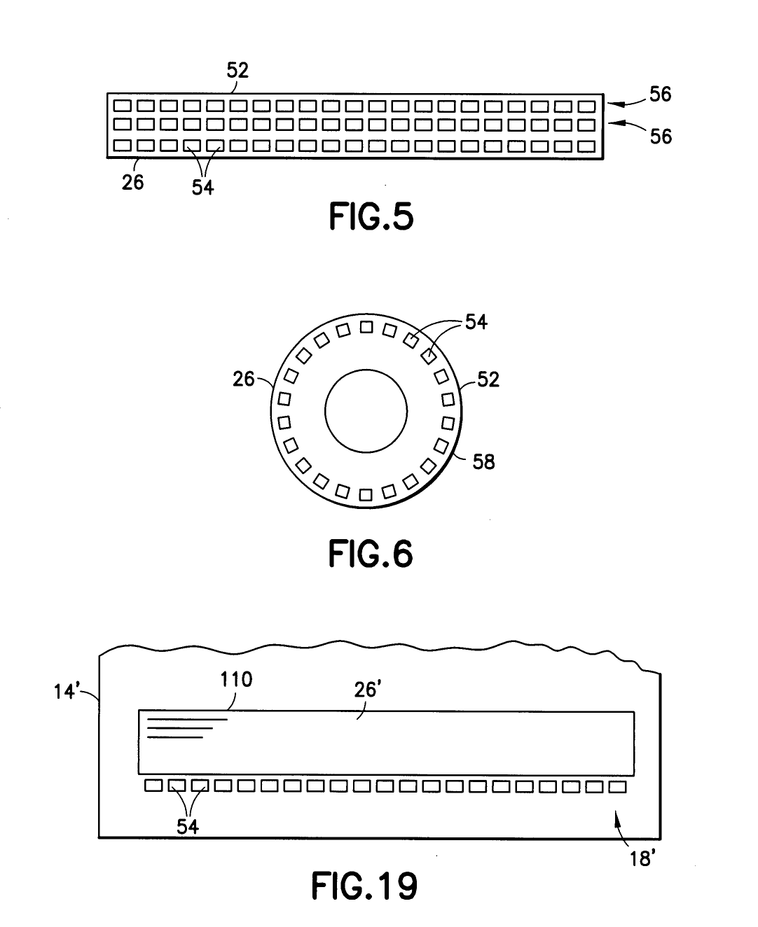

Referring also to FIGS. 5 and 6, in this embodiment the roller 26 comprises a frame 52 and a plurality of sensors 54 which form the finger sensor 30. The frame 52 has a general column or tube shape. The sensors 54 are adapted to sense contact of the finger of a user therewith (or in very close proximity thereto). In this embodiment, the sensors are adapted to sense the location of a user's finger relative to the longitudinal length of the roller 26. For example, the sensors 54 could be capacitive sensors. However, in alternate embodiments, any suitable type of sensors for sensing location of a user's finger relative to the longitudinal length of the roller 26 could be provided. The sensors 54 are connected to the frame 52 in a general series of rows 56 arranged in a circular pattern to form a general column or tube shape of sensors. The sensors 54 are located at (or very close to) the exterior surface 58 of the frame 52.

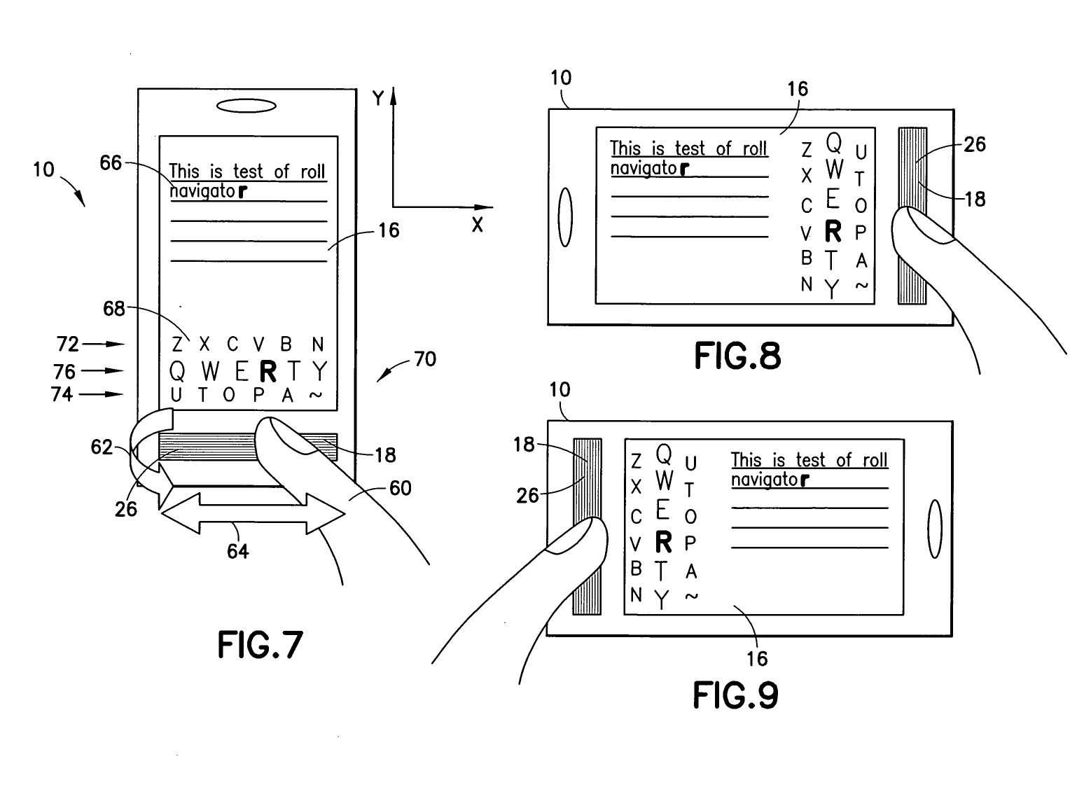

Referring also to FIG. 7, the user input 18 can be used similar to a trackball to move or navigate user control on the display 16 such as a cursor, or icon or text highlighter, or menu item, etc. However, where a trackball rotates in two axes, the roller 26 only needs to rotate in a single axis. The user can use a finger 60 to axially rotate the roller 26 to control navigation on the display 16 in axis Y (“+” or “−”) as indicated by arrow 62. At the same time, or before or after, the user can use the finger 60 to control navigation on the display 16 in axis X (“+” or “−”) as indicated by arrow 64 based upon the location of the finger 60 along or relative to the longitudinal length of the roller 26. This location is sensed by the sensors 54. Thus, with the use of one single axis rotation roller, the input device can navigate control on the display 16 in two axes (X and Y).

Additionally, or alternatively, actuating the force sensor 32 could cause the software of the apparatus to activate a “zoom” feature rather than a “select” feature. Thus, when viewing a picture image, or map, or other screen on the display 16 which can be enlarged or reduced, depressing the roller 26 to actuate the force sensor 32 could cause the portion of the image being displayed to zoom in or zoom out. As another use of the invention, besides X-axis and Y-axis movement or navigation control when the roller 26 is axially rotated, the invention could also be used zoom control when the roller 26 is rotated, such as when viewing a picture image, or map, or other screen which can be enlarged or reduced. For example, the input 18 could be adapted to be depressed to actuate the force sensor 32 while the roller 26 is axially rotated to zoom in or out on the image displayed in the display 16.

In the embodiment shown in FIG. 7, the device is being used to create a text message in area 66 by highlighting and then selecting letters in area 68. The letter “R” is highlighted in area 68 and, if the roller 26 is depressed, the letter “R” will be selected to be inserted into the text creation area 66. If the user moves or slides his finger 60 left, the highlighted letter will change from “R” to “E”. Further movement of the finger 60 left will change the highlighted letter from “E” to “W” to “Q”. If the user moves or slides his finger 60 right, the highlighted letter will change from “R” to “T” and to “Y” if moved further right. At any time a user can depress the roller to select a highlighted letter. If a desired letter in not in the row 70 of letters, the user can axially rotate the roller 26 to move the row 72 or row 74 into the selectably row position 76.

In the embodiment shown, rows 72, 74 of letters on opposite sides of the row in the selectably row position 76 are shown for user interface prediction purposes; the user knowing which way to rotate the roller 26 to get to the desired letter faster. However, in an alternate embodiment, this might not be provided. As noted from the further description below, the invention is not limited merely to text or letter/number identification and selection in text writing. The invention can be used for other well known portable electronic device features including, for example, cursor movement, icon highlighting, or any other display control previously provided by a trackball or multi-key keypad or touch-screen or joystick type of user input.

Referring also to FIGS. 8 and 9, these figures illustrate one advantage of the invention. With the present invention, the form factor of the user input 18 and display 16 with the housing, allows left and right hand use of the same device 10 in a portrait configuration of the device 10 and display 16. This cold include having the roller on the right side of the display 16 for right-handed use as shown in FIG. 8 and having the roller on the left side of the display 16 for left-handed use as shown in FIG. 9. The user could change a setting in a control menu of the software of the device for setting right handed or left handed configuration. In an alternate embodiment, the device 10 could have an orientation sensor 78, as shown in FIG. 3, for the device to automatically select orientation of the screen displayed on the display 16.

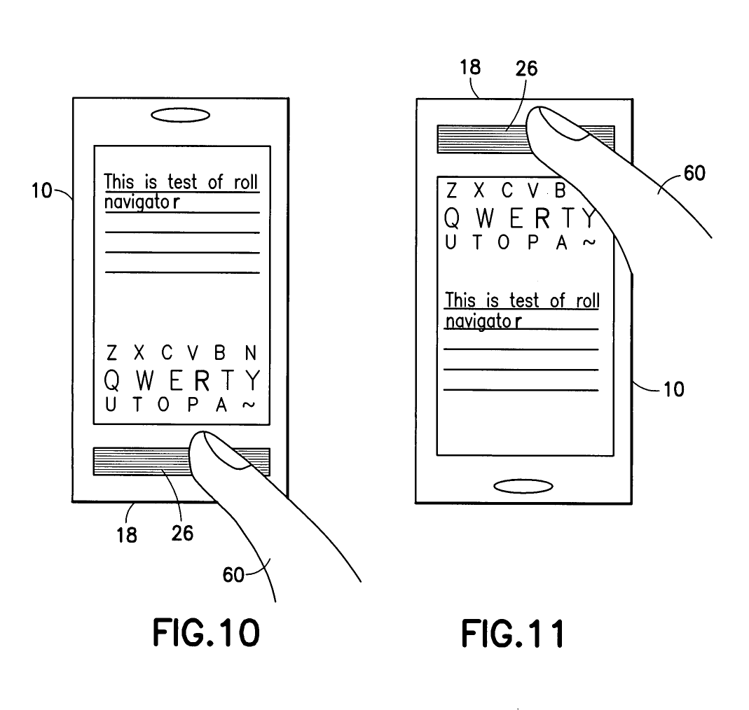

Referring also to FIGS. 10 and 11, the form factor of the user input 18 and display 16 with the housing 14 allow use of the same device 10 in a landscape configuration of the housing 14 and display 16. This could include having the roller 26 at the bottom as shown in FIG. 10 or at the top as shown in FIG. 11. The user could change a setting from a control menu of the software of the device for setting a top or bottom roller location configuration. In an alternate embodiment, the orientation sensor 78 could be used to automatically select orientation of the screen displayed on the display 16 for the top or bottom roller location configuration. Alternatively, or additionally, the application software could automatically select orientation of the screen displayed on the display 16 for the top or bottom roller location configuration based upon aspects of the application. Thus, the invention can be used to support a rotatable screen for all four situations shown in FIGS. 8-11 (portrait or landscape screen orientation, right or left roller location, or top or bottom roller location).

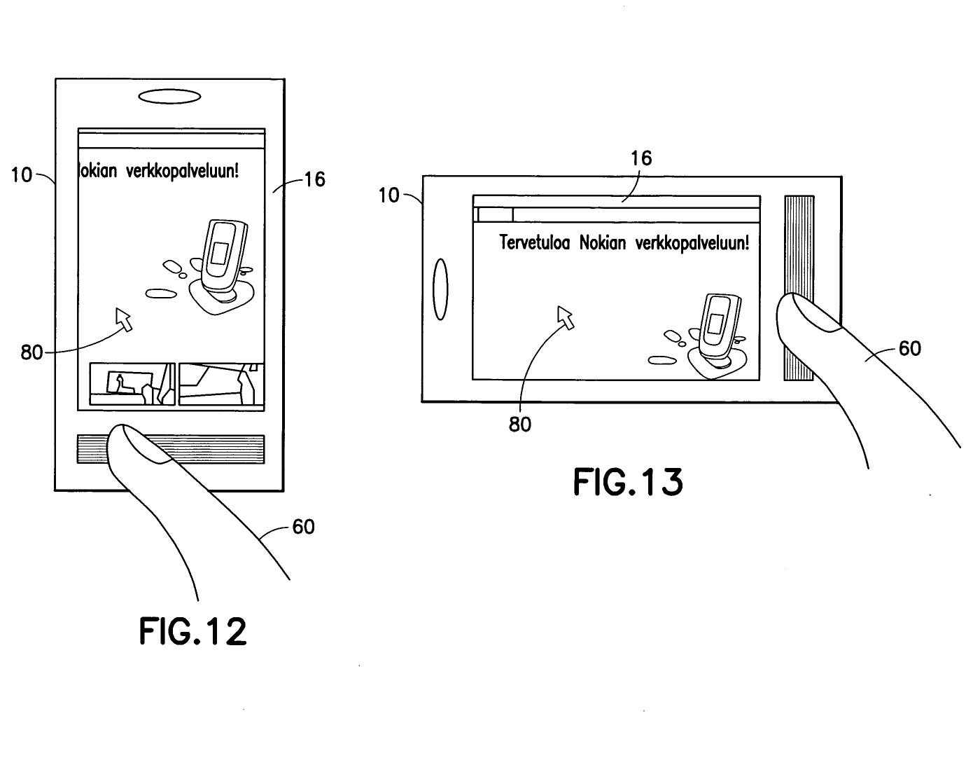

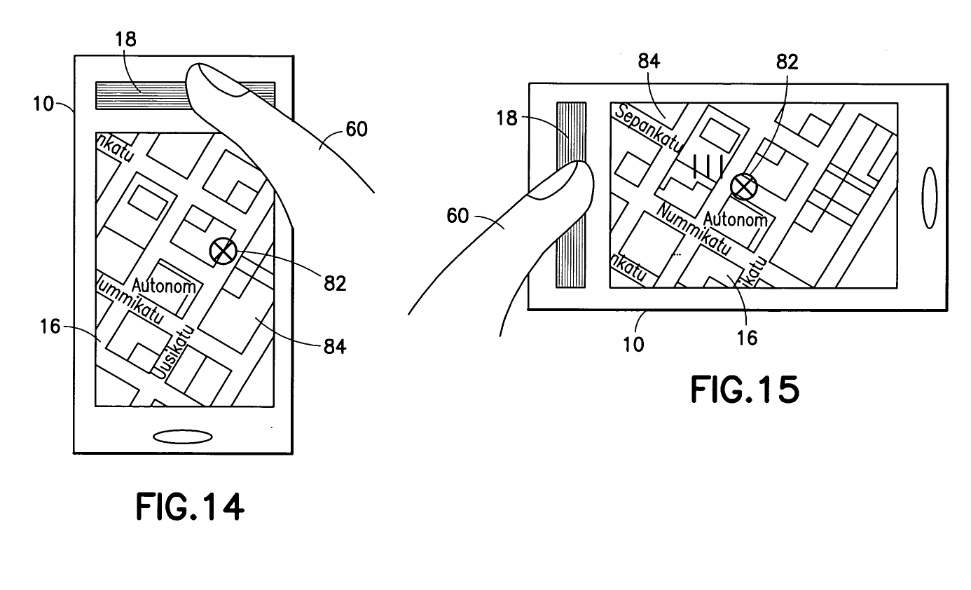

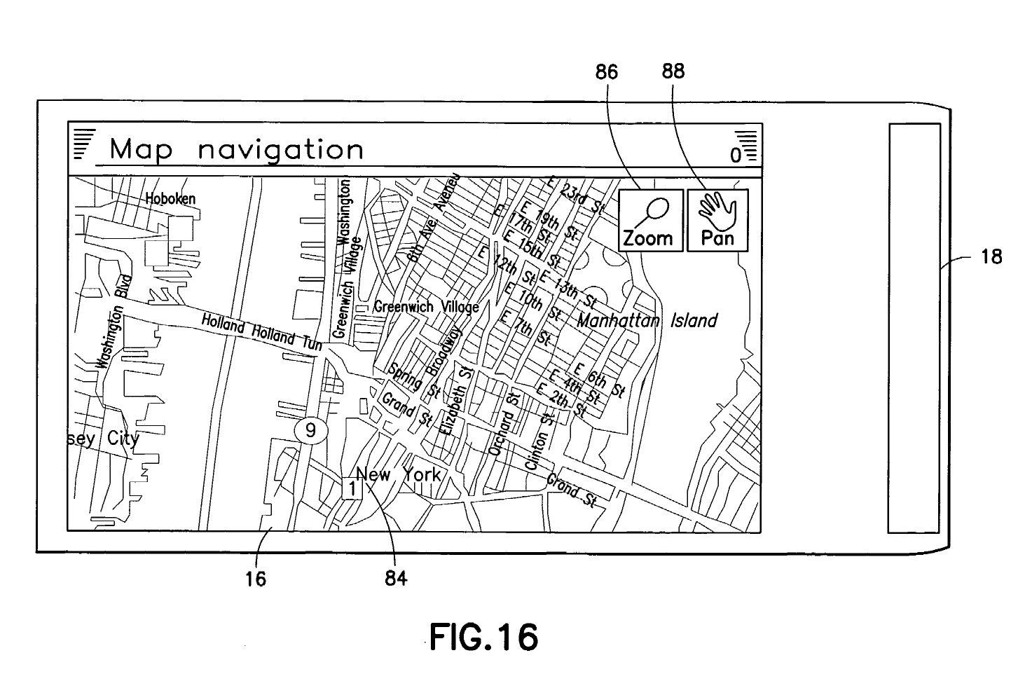

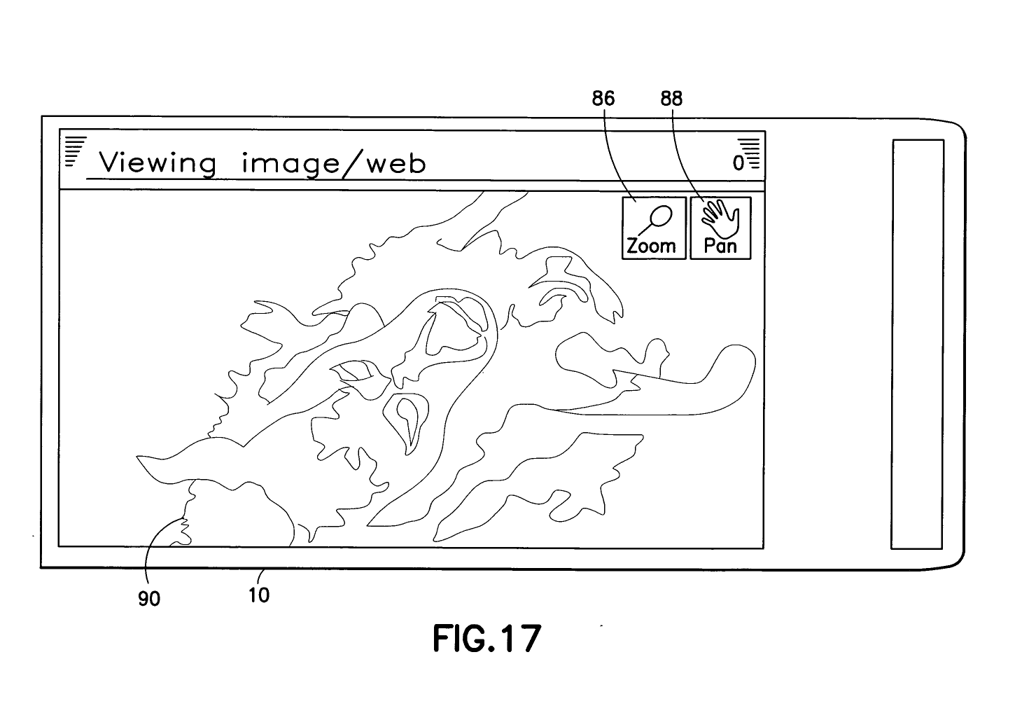

FIGS. 12 and 13 illustrate that the input device 18 can be used for controlling movement of a cursor 80 on the display 16 in either a portrait or landscape orientation. FIGS. 14 and 15 illustrate that the input device 18 can be used for controlling movement of a navigation marker 82 in a navigation application having a map screen 84 displayed on the display 16. FIG. 16 shows how control icons 86, 88 can be shown on the display screen 84 for a user to highlight and select using the user input device 18. Besides text input and cursor or navigation control, the input can be used for scrolling and panning images or web pages. FIG. 17 illustrates use of the invention with an image viewer application, such as when the device 10 has a camera for taking and displaying a digital picture image 90; or for controlling aspects of a digital video player application. In the embodiments noted above with regard to FIGS. 12-15, the cursor can move on the display screen when the user rolls the roller. In another embodiment or application, the screen on the display could move when the user rolls the roller.

In the embodiments described above, the software merely uses the real-time location of a user's finger (as sensed by the finger sensor portion of the user input) as an input signal. In one type of alternate embodiment, movement of the user's finger (as sensed by the finger sensor portion of the user input) could also be used to control another feature. For example, speed or velocity of the user's finger could be used to generate a different speed or velocity of control on the display. As one specific example, a fast moving finger along the length of the roller 26 could be used to move the cursor quickly or scroll through a long web page quickly.

In another embodiment, location of a user's finger at a specific location on the roller's length could have a unique control characteristic. For example, when a user's finger comes in the end of the roller, the content of the display or the content of the active part of the display might continue. As one specific example in map navigation, the view of the map could continue when the user's finger is located at the end of the roller. It is not necessary that the whole screen on the display move; when inputting Chinese text for example.

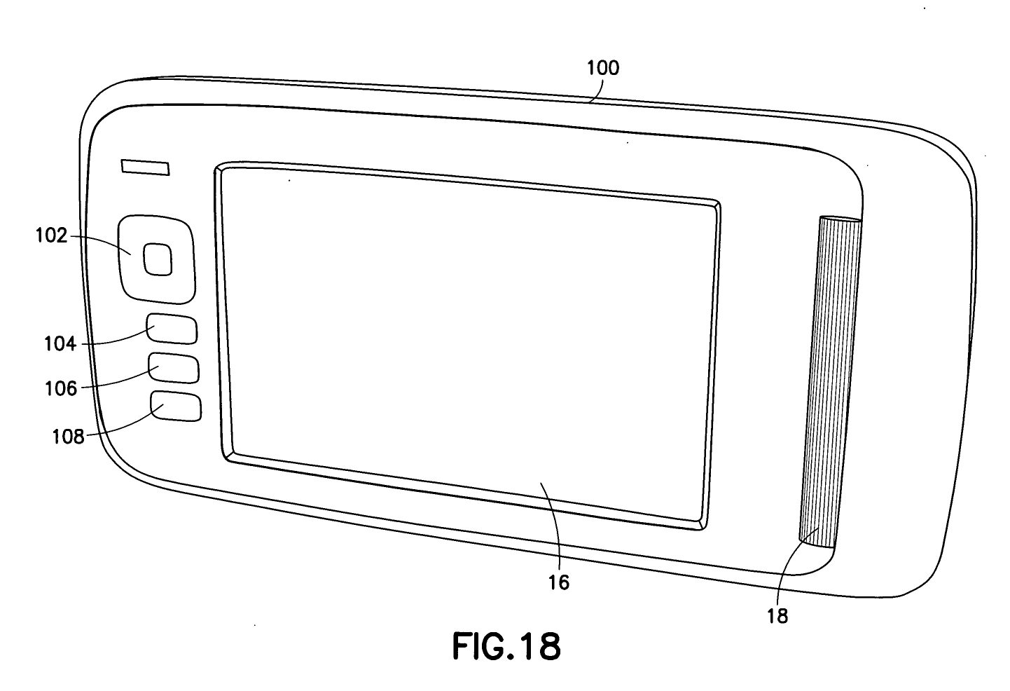

Referring also to FIG. 18, another embodiment is shown. In this embodiment the device 100 is identical to the device 10, but includes additional user input controls 102, 104, 106, 108. In this embodiment, the user input control 102 is a five-way navigation control, and user input controls 104, 106 and 108 are depressible keys. However, any suitable additional user inputs besides the user input 18 could be provided.

Referring also to FIG. 19, another alternate embodiment is shown. In this embodiment, the user input 18′ has a roller 26′ which does not have the sensors 54 therein. Instead, the sensors 54 are mounted to the housing 14′ along one edge of the hole 110 which the roller 26′ is located in. The position of the finger of the user relative to the longitudinal length of the roller 26′ is sensed by the sensors 54 on the housing 14′. In this embodiment the roller 26′ might be further recessed in the hole 110 than the embodiment shown in FIG. 1 to insure contact of the sensors 54 by the user's finger.

With the present invention, alphanumeric characters and/or other keys and symbols can be organized into rows which a user can scroll through as shown in the first embodiment with the relatively wide roller. Choosing the right character or symbol in the row can be done by detecting the finger positioning in the roller. Selection can be done, for example, by clicking down on the roller. Browsing and navigation can be done with similar roller control.

The invention can be used, for example, in all products that have a small size, and still, provide a large display. The invention can be used, for example, in specially products that need browsing and navigating capabilities or QWERTY. Also it enhances products ergonomics by enabling as big symbols “keys” as needed (even several centimeters high). For example, the characters in the selectably row position 76 can be enlarged for easier reading and easier selecting without selection errors.

Advantages and disadvantages include freedom of using the product in every position, and a watertight user interface (UI) when using a “Magnet Roller”. No variant to hardware or mechanics is needed to accommodate language variants. The invention provides a scaleable and customizable UI. All user screen control interface “buttons” can be merged to one roller. In addition, the invention provides a good mechanical felling and tactile feeling. With the invention, a user does not cover symbols of the buttons with their finger during use.

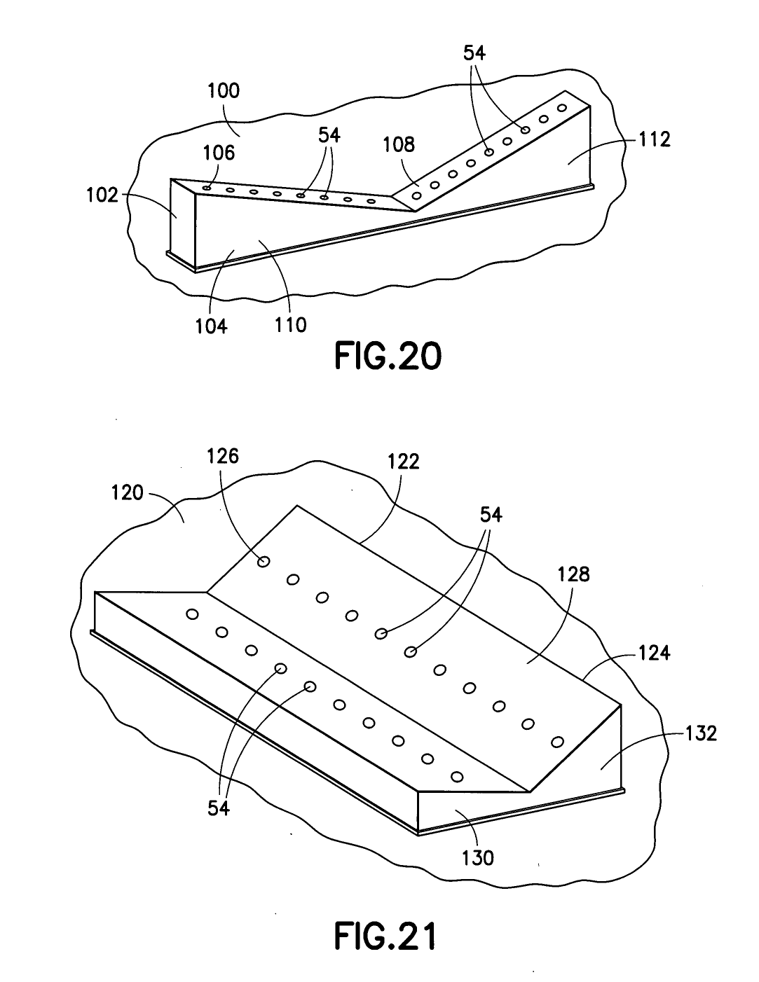

Referring to FIG. 20, another embodiment of the invention is shown. In this embodiment the device 100 is identical to the device 10 except that the user input 18 has been replaced with a user input 102. The user input 102 generally comprises a rocker switch 104 which has a finger location sensor 106 with a plurality of sensors 54. The sensors 54 are located in the switch 104 and arranged along the longitudinal length of the switch 104 proximate the top side 108. The top side 108 has an elongate length which is at least two times longer than a fingertip of the user. The user can alternatingly depress the two opposite rocker sections 110, 112 to control a first user input function, and the sensors 54 can sense location of the user's fingertip relative to the longitudinal length of the top side 108 to control a second user input function.

Referring to FIG. 21, another embodiment of the invention is shown. In this embodiment the device 120 is identical to the device 10 except that the user input 18 has been replaced with a user input 122. The user input 122 generally comprises a rocker switch 124 which has a finger location sensor 126 with a plurality of sensors 54. The sensors 54 are located in the switch 124 and arranged in two rows along the longitudinal width of the rocker sections 130, 132 of the switch 104 proximate the top side 128. The top side of the rocker section 130 and the top side of the rocker section 132 each have an elongate width which is at least two times longer than a fingertip of the user. The user can alternatingly depress the two opposite rocker sections 130, 132 to control a first user input function, and the sensors 54 can sense location of the user's finger relative to the longitudinal width of the top side 128 to control a second user input function. This embodiment shows a user input with two rows of sensors; one on each of the rocker sections 130, 132. In an alternate embodiment, such as when the rocker switch is small or when the sensor area of the sensors are large, there might only be one row or line of sensors which could be actuated by a user's finger regardless of whether the user was depressing the first rocker section 130 or the second rocker section 132. The embodiment with a single row of sensors might be a preferred embodiment; possible having reduced manufacturing costs.

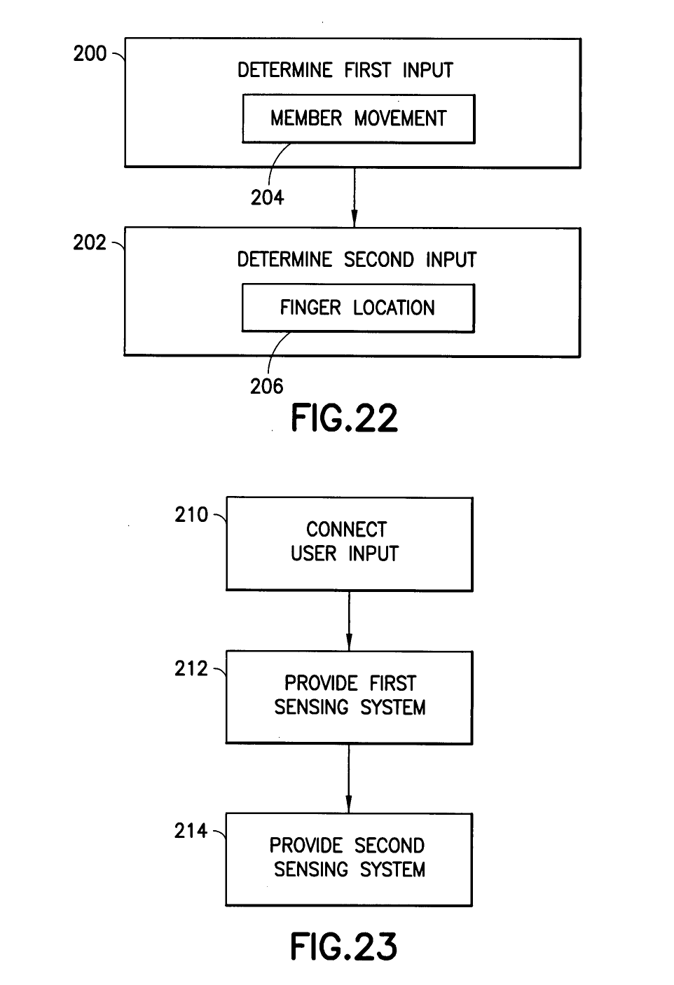

Referring also to FIG. 22, in one of its general methods of use, the invention can comprise determining a first input as indicated by block 200 and determining a second input as indicated by block 202. The step of determining the first input comprises sensing movement of a member as indicated by block 204, such as axial rotation of a roller or movement of a rocker switch for example. The step of determining the second input comprises sensing location, as indicated by block 206, of the user's finger being used to move the member sensed in block 204.

Referring also to FIG. 23, in one general method of assembling a device comprising the invention, the user input is connected to the frame of the device as indicated by block 210. The method includes providing a first sensing system, as indicated by block 212, for sensing movement of a member of the user input by a user, and providing a second sensing system, as indicated by block 214, for sensing the location of a user's finger being used to move the member sensed in block 212.

It should be understood that the foregoing description is only illustrative of the invention. Various alternatives and modifications can be devised by those skilled in the art without departing from the invention. Accordingly, the invention is intended to embrace all such alternatives, modifications and variances which fall within the scope of the appended claims.

What is claimed is:

1. A user input device for an electronic apparatus, the user input device comprising:
a roller adapted to be axially rotated by a user, wherein the roller comprises an elongate longitudinal length; and
a sensor system adapted to sense a position of the finger of the user relative to the longitudinal length of the roller.

2. A user input device as in claim 1 wherein the sensor system comprises capacitive sensors located in the roller.

3. A user input device as in claim 2 wherein the capacitive sensors comprise a plurality of rows of the sensors arranged in a general column shaped pattern.

4. A user input device as in claim 1 wherein the sensor system comprises capacitive sensors located in close proximity to the roller.

5. A user input device as in claim 4 wherein the capacitive sensors comprise a row of the capacitive sensors aligned next to the roller along the length of the roller.

6. A user input device as in claim 1 further comprising a selector sensor adapted to sense depression of the roller by the user.

7. A user input device as in claim 1 the elongate longitudinal length of the roller comprises a length which is at least two times longer than a width of a finger of the user.

8. An apparatus comprising:
a housing;
a display connected to the housing;
a controller connected to the display; and
a user input device as in claim 1 connected to the controller.

9. An apparatus as in claim 8 wherein the apparatus comprises a mobile telephone having a transceiver.

10. An apparatus as in claim 8 wherein the display forms a substantial majority of a first side of the housing of the hand-held portable electronic device, and wherein the roller is located on the first side of the housing aligned with one side of the display.

11. An apparatus as in claim 10 wherein the display has a general rectangular shape, and wherein the roller is aligned with a smaller side of the general rectangular shape of the display.

12. An apparatus comprising:
a housing;
a display connected to the housing;
a controller connected to the display; and
a user input connected to the controller, wherein the user input comprises a roller adapted to be axially rotated relative to the housing by a finger of a user to change information displayed on the display, and a sensor for sensing positions of the finger of the user relative to the roller.

13. An apparatus as in claim 12 wherein the apparatus comprises a mobile telephone having a transceiver.

14. An apparatus as in claim 12 wherein the display forms a substantial majority of a first side of the housing of the hand-held portable electronic device, and wherein the roller is located on the first side of the housing aligned with one side of the display.

15. An apparatus as in claim 14 wherein the display has a general rectangular shape, and wherein the roller is aligned with a smaller side of the general rectangular shape of the display.

16. An apparatus as in claim 12 wherein the sensor comprises capacitive sensors located in the roller.

17. An apparatus as in claim 16 wherein the capacitive sensors comprise a plurality of rows of the capacitive sensors arranged in a general column shaped pattern.

18. An apparatus as in claim 12 wherein the sensor comprises capacitive sensors located on the housing in close proximity to the roller.

19. An apparatus as in claim 18 wherein the capacitive sensors comprise a row of the capacitive sensors aligned next to the roller along the length of the roller.

20. An apparatus as in claim 12 further comprising a selector sensor adapted to sense depression of the roller by the user.

21. A method of controlling navigation on a display comprising:
determining a first input for use in determining a first portion of a position of an item being navigated on the display based, at least partially, upon axial rotation of a user input roller; and
determining a second input for use in determining a second portion of a position of the item being navigated on the display based, at least partially, upon a location of a finger of the user on and relative to the user input roller.

22. A method as in claim 21 wherein determining the second input comprises receiving the second input from a capacitive sensor of a plurality of capacitive sensors in the roller which senses relative location of the finger of the user on the roller.

23. A method as in claim 21 wherein determining the second input comprises receiving the second input from a capacitive sensor of a plurality of capacitive sensors in a row along an elongate side of the roller which senses location of the finger of the user relative to the roller.

24. A method of assembling a portable electronic device comprising:
connecting a user input roller to a frame of the portable electronic device, wherein the roller has an elongate longitudinal length;
providing a first sensing system adapted to sense axial rotation of the roller relative to the housing; and
providing a second sensing system adapted to sense a location of a finger of a user at a plurality of locations along the longitudinal length of the roller.

25. A method as in claim 24 wherein providing a second sensing system comprises providing a series of rows of capacitive sensors in the roller in a general column shape.

26. A method as in claim 24 wherein providing a second sensing system comprises providing a row of capacitive sensors on a housing of the portable electronic device along a longitudinal length of the roller.

27. A program storage device readable by a machine, tangibly embodying a program of instructions executable by the machine for performing operations to control navigation on a display, the operations comprising:
determining a first portion of a position of an item being navigated on the display based, at least partially, upon axial rotation of a user input roller; and
determining a second portion of a position of the item being navigated on the display based, at least partially, upon a location of a finger of the user on and relative to the user input roller.

28. A user input device for an electronic apparatus, the user input device comprising:
a user movement member adapted to be pivoted by a user about an axis, wherein the user movement member comprises an elongate length or width which is at least two times longer than a width of a finger of the user; and
a sensor system adapted to sense a position of the finger of the user relative to the elongate length of the user movement member.

29. A user input device as in claim 28 wherein the user movement member is a roller.

30. A user input device as in claim 28 wherein the user movement member is a rocker switch.

31. An apparatus comprising:
a housing;
a display connected to the housing;
a controller connected to the display; and
a user input device as in claim 28 connected to the controller.
